(19) United States
(12) Patent Application Publication
(10) Pub. No.: US 2012/0156540 A1
(43) Pub. Date: Jun. 21, 2012

(54) Rechargeable Battery with Heat Sink

(76) Inventor: Yu-Cheng Hsu, Taipei City (TW)

(21) Appl. No.: 12/969,609

(22) Filed: Dec. 16, 2010

(51) Int. Cl. H01M 10/50

(52) U.S. Cl. 429/120

(57) ABSTRACT

The rechargeable battery includes a battery body and heat sink thereon. The heat sink is provided with a plurality of longitudinal fins. A longitudinal trough is formed between each two adjacent fins. An annular trough is formed transversely through the fins. The annular trough is orthogonal to the fins. The heat sink dissipates the heat from the battery body by means of the fins, longitudinal trough and annular trough.

### BACKGROUND OF THE INVENTION

1. Technical Field

The invention relates to batteries, particularly to batteries with heat sinks.

2. Related Art

With the popularity of portable electronic devices, batteries play an important role. A usable time and cost of electric power of a portable electronic device depends on performance of batteries. Thus rechargeable batteries have become absolutely necessary.

Unavoidably, the charge or discharge of rechargeable batteries must invite an exothermic reaction. This will make the internal temperature of rechargeable batteries rise. Those warm or hot batteries will generate a thermal resistance to reduce their performance. Thus, to keep performance of the rechargeable batteries stable, the solution of heat dissipation of the rechargeable batteries is a key point.

A typical rechargeable battery is shown in FIG. 1. The rechargeable battery 10 has a battery body 101. A surface of the battery body 101 is smooth. The heat from the battery 10 is conducted onto the surface to dissipate out. Usually, the battery 10 is used in a closed room, which is disadvantageous to heat dissipation. As abovementioned, the insufficient heat dissipation ability will make the battery temperature increasing and reduce the performance of batteries.

### SUMMARY OF THE INVENTION

An object of the invention is to provide a rechargeable battery with heat sink, which can improve the heat dissipation ability of rechargeable battery to efficiently dissipate the heat from the battery.

To accomplish the above object, the rechargeable battery of the invention includes a battery body and heat sink thereon. The heat sink is provided with a plurality of longitudinal fins. A longitudinal trough is formed between each two adjacent fins. An annular trough is formed transversely through the fins. The annular trough is orthogonal to the fins. The heat sink dissipates the heat from the battery body by means of the fins, longitudinal trough and annular trough.

### BRIEF DESCRIPTION OF THE DRAWINGS

FIG. 1 is schematic view of a conventional battery;

FIG. 2 is a perspective view of the invention;

FIG. 3 is a cross-sectional view of the invention;

FIG. 4 a partial side view of the invention;

FIG. 5 is a partially enlarged cross-sectional view of another embodiment of the fins;

FIG. 6 is a partially enlarged cross-sectional view of still another embodiment of the fins;

FIG. 7 is a partially enlarged cross-sectional view of yet another embodiment of the fins;

FIG. 8 is a side view of another embodiment of the annular trough; and

FIG. 9 is a cross-sectional view of another embodiment of the battery body.

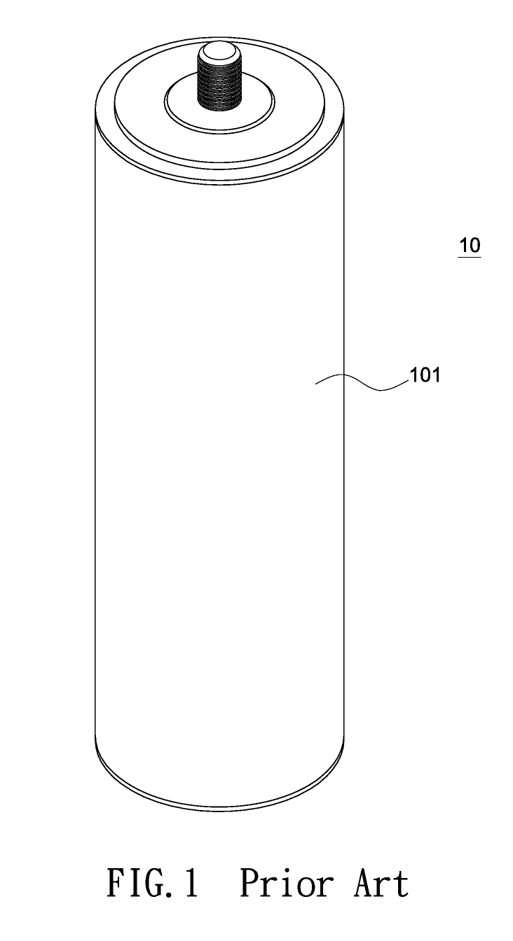

### DETAILED DESCRIPTION OF THE INVENTION

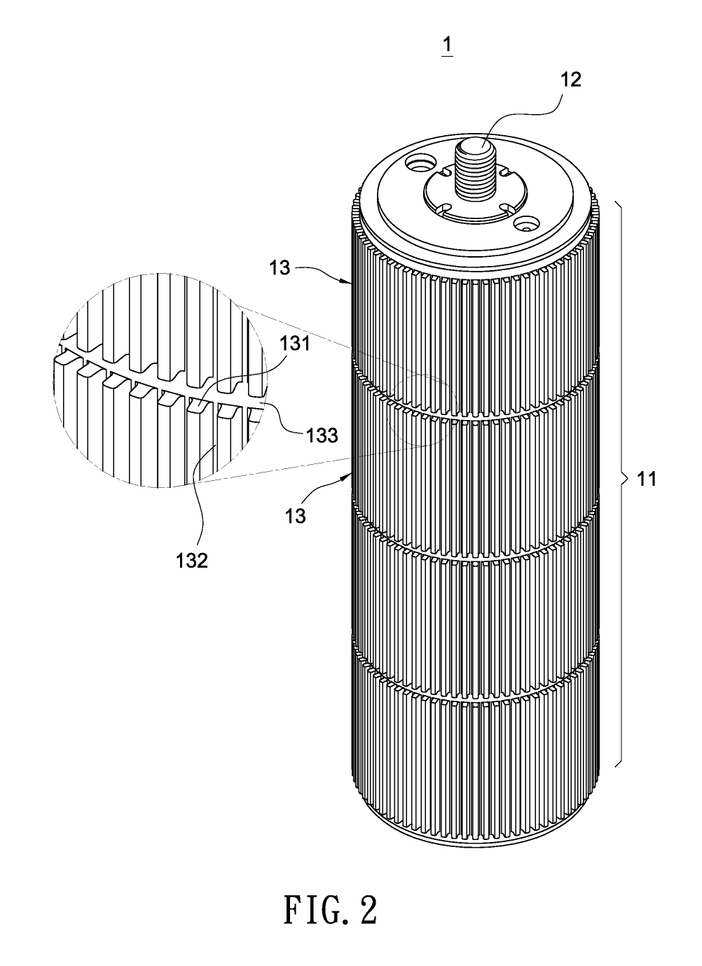

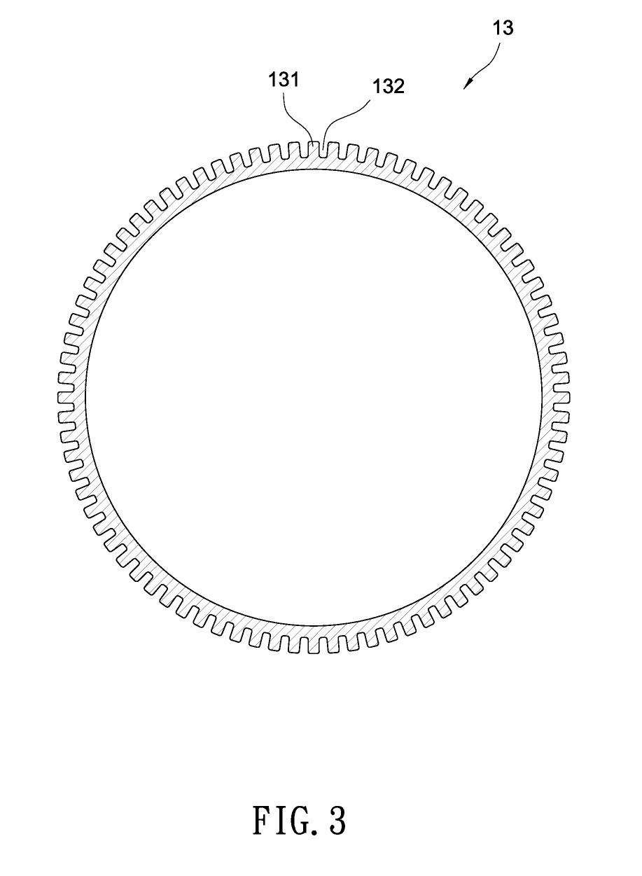

Please refer to FIG. 2. As can be seen, the battery 1 includes a battery body 11. In this embodiment, the battery body 11 is of a cylindrical shape. The battery body 11 is filled with one or more electrochemical cells. One end of the battery body 11 is provided with an electrode plug 12 for connecting electricity. A surface of the battery body 11 is provided with a heat sink 13. The heat sink 13 is made of great thermo-conductive material such as aluminum. The heat sink 13 has a plurality of fins 131 which are radially arranged as shown in FIG. 3. A longitudinal trough 132 is formed between each two adjacent fins 131 to promote air convection.

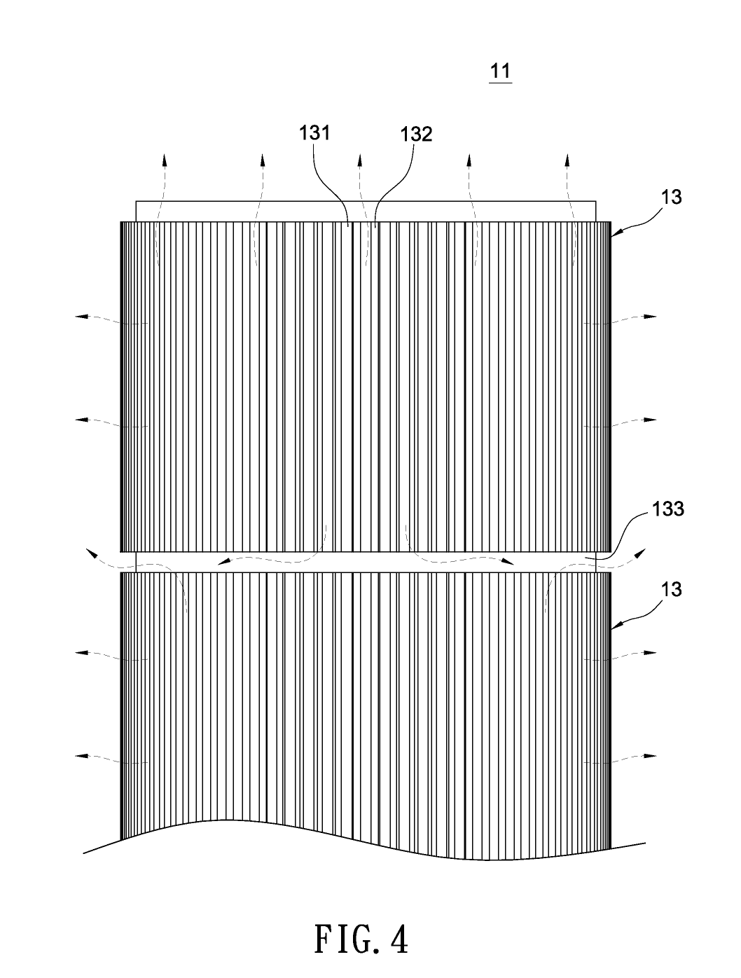

Please refer to FIG. 4. At least one annular trough 133 is transversely formed on the heat sink 13 through the fins 131. In this embodiment, there are three annular troughs 133. The annular troughs 133 are orthogonal to the longitudinal troughs 132. Thus the heat resulting from the charge or discharge reaction of the battery body 11 will be conducted onto the heat sink 13 and dissipated via not only the fins 131 but also the longitudinal troughs 132 and annular troughs 133. As can be seen in FIG. 4, air will flow along the longitudinal troughs 132 and annular troughs 133 to carry heat away from the fins 131. By the heat dissipation of the heat sink 13, the temperature of the battery 1 may be lowered and the performance thereof may also be improved.

The heat sink 13 on the battery body 11 can increase the surface area for heat exchange. Further, the longitudinal troughs 132 and annular troughs 133 may provide air convection so that the heat may be efficiently dissipated.

According to Fourier's law of heat conduction:

Q=−kA(T₂−T₁)

where k is a proportional constant, A is a cross-sectional area through which heat is transferred and T₂ and T₁ are temperature at two ends of the heat sink.

In other words, the heat which is transferred by conduction, Q, is proportional to the product of the temperature difference and the cross-sectional area through which heat is transferred. That is, when the cross-sectional area increases, the heat which is carried away by the heat sink proportionally increases. Therefore, the heat from the battery body 11 can be indeed dissipated.

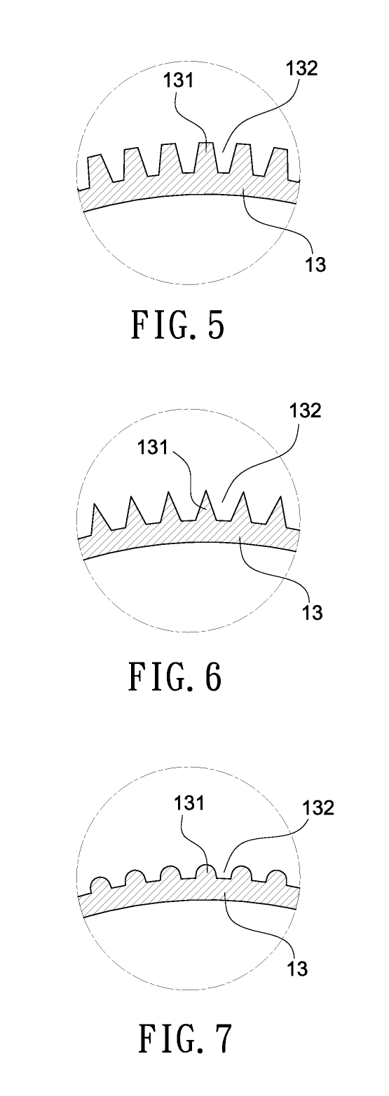

Additionally, besides rectangular as shown above, the cross-section of the fins 131 may also be trapezoidal (as shown in FIG. 5), triangular (as shown in FIG. 6) or semicircular (as shown in FIG. 7).

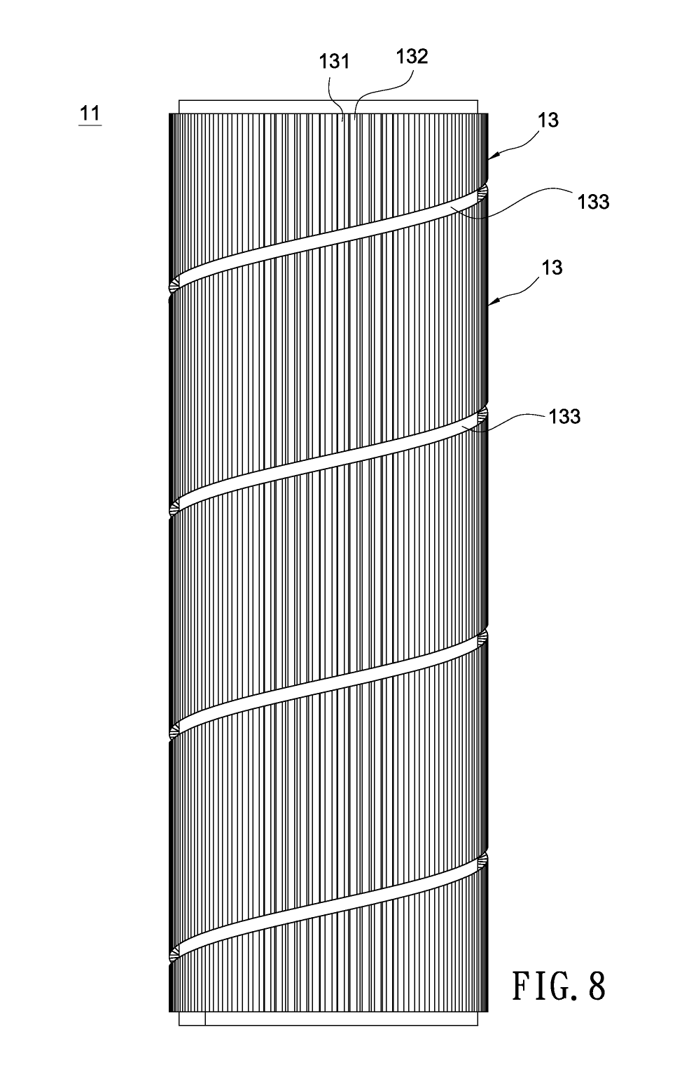

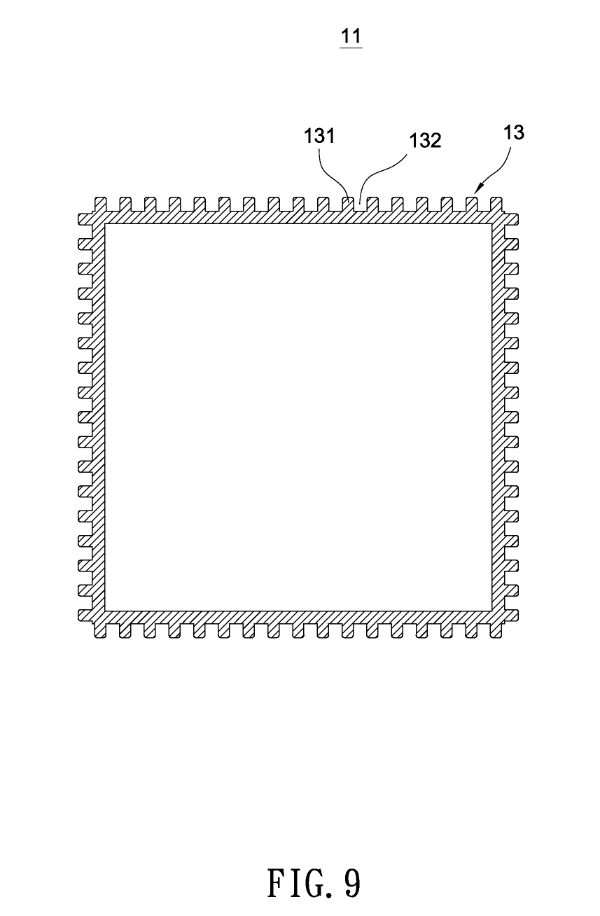

The annular trough 133 may also be spirally disposed on the heat sink 13 as shown in FIG. 8. The battery body 11 may also be square as shown in FIG. 9.

Those skilled in the art will appreciate that numerous changes and modifications can be made to the preferred embodiments of the invention, and that such changes and modifications can be made without departing from the spirit of the invention.

What is claimed is:

1. A rechargeable battery comprising:
a battery body;
a heat sink, disposed on the battery body, having a plurality of fins radially arranged, wherein a longitudinal trough is formed between each two adjacent fins.

2. The rechargeable battery of claim 1, wherein an annular trough is disposed on the heat sink through the fins and the longitudinal troughs.

3. The rechargeable battery of claim 1, wherein the heat sink is made of thermo-conductive material.

4. The rechargeable battery of claim 1, wherein a cross-section of the fin is square.

5. The rechargeable battery of claim 1, wherein a cross-section of the fin is trapezoidal.

6. The rechargeable battery of claim 1, wherein a cross-section of the fin is triangular.

7. The rechargeable battery of claim 1, wherein a cross-section of the fin is semicircular.

8. The rechargeable battery of claim 1, wherein the battery body is of a cylindrical shape.

9. The rechargeable battery of claim 1, wherein the battery of is a right prism in shape.
